(19) United States
(12) Patent Application Publication
(10) Pub. No.: US 2019/0250810 A1
(43) Pub. Date: Aug. 15, 2019

(54) IMAGE PROCESSING APPARATUS, SCREEN HANDLING METHOD, AND COMPUTER PROGRAM

(71) Applicant: KONICA MINOLTA, INC., Tokyo (JP)

(72) Inventors: Kana Yamauchi, Anjo-shi (JP); Takuto Matsumoto, Toyohashi-shi (JP); Tomohiro Yamaguchi, Shinshiro-shi (JP); Kunihiro Miwa, Inazawa-shi (JP)

(73) Assignee: KONICA MINOLTA, INC., Tokyo (JP)

(21) Appl. No.: 16/260,410

(22) Filed: Jan. 29, 2019

(30) Foreign Application Priority Data
Feb. 15, 2018 (JP) 2018-024824

(51) Int. Cl. G06F 3/0488; G06F 3/0485; G06F 3/0482

(52) U.S. Cl. CPC G06F 3/04883; G06F 2203/04803; G06F 3/0482; G06F 3/0485

(57) ABSTRACT

An image processing apparatus includes: a display part that causes a touch panel display to display a first screen and a second screen adjacent to each other, the second screen being provided with a first area which is responsive to a slide operation performed by a pointer being slid in a direction of the first screen and a second area which is not responsive to the slide operation; a determiner that determines that the slide operation has been performed not on the first screen but in the first area in a case where the slide operation has been performed from the first area to the first screen; and a processor that performs a process based on a result of determination by the determiner.

The entire disclosure of Japanese patent Application No. 2018-024824, filed on Feb. 15, 2018, is incorporated herein by reference in its entirety.

### BACKGROUND

### Technological Field

The present invention relates to a technique of a user interface for simultaneously displaying a plurality of arranged screens.

### Description of the Related Art

Image forming apparatuses having various functions such as a copy function, a scanning function, a facsimile function, and a box function are in widespread use. Such an image forming apparatus is referred to as a “multifunction peripheral (MFP)” in some cases.

Furthermore, in recent years, a technique of integrally configuring an image forming apparatus with a physical server (so-called server machine or server unit) has been proposed. The technique can more easily improve the expandability of functions of image forming apparatuses than the conventional technique. Hereinafter, an image forming apparatus integrated with a server is described as a “multifunction machine.”

Different operating systems are installed in the image forming apparatus and the server.

A touch panel display of the multifunction machine simultaneously displays respective screens of the image forming apparatus and the server side by side so as to accept user operations for each of the image forming apparatus and the server.

In addition, the following techniques have been proposed as techniques of using a display divided into a plurality of sections.

A control part of a display system having a display screen is caused to function as a first image display control part, an image erasure control part, and a second image display control part. The first image display control part causes an image to be displayed. The image erasure control part erases the image caused to be displayed, by the first image display control part, when a slide operation is performed on the display screen. When the image is erased, the second image display control part sets a virtual straight line dividing the display screen into two sections based on a starting point and an ending point of the slide operation, and causes an image to be displayed on each of the two sections of the display screen divided by the virtual straight line (JP 2013-225232 A).

There is obtained a horizontal slide signal along a touch screen or a vertical slide signal along the touch screen, input by use of the touch screen. A current display area of the touch screen is divided into at least two display windows vertically arranged according to the horizontal slide signal. Alternatively, the current display area of the touch screen is divided into at least two display windows horizontally arranged according to the vertical slide signal. Then, a plurality of application programs arranged vertically or horizontally is simultaneously displayed on the screen (JP 2015-520465 A).

Operations of a touch panel display include those performed by a user sliding a finger while touching the touch panel display, such as flick, drag, and swipe-in operations. When a plurality of screens is arranged, a finger may touch not only a screen to be operated but also another screen which should not be touched while the finger is slid thereon. Then, there are cases where a process that a user does not intend is performed.

### SUMMARY

In view of such problems, an object of the present invention is to further improve operability of a plurality of arranged screens being displayed, as compared to the conventional techniques.

To achieve the abovementioned object, according to an aspect of the present invention, an image processing apparatus reflecting one aspect of the present invention comprises: a display part that causes a touch panel display to display a first screen and a second screen adjacent to each other, the second screen being provided with a first area which is responsive to a slide operation performed by a pointer being slid in a direction of the first screen and a second area which is not responsive to the slide operation; a determiner that determines that the slide operation has been performed not on the first screen but in the first area in a case where the slide operation has been performed from the first area to the first screen; and a processor that performs a process based on a result of determination by the determiner.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an example of a network system including a multifunction machine;

FIG. 2 is a diagram showing an example of a hardware configuration of the multifunction machine;

FIG. 3 is a diagram showing an example of a hardware configuration of an MFP unit;

FIG. 4 is a diagram showing an example of a hardware configuration of a server unit;

FIG. 5 is a diagram showing an example of a hardware configuration of a panel controller;

FIG. 6 is a diagram showing an example of a functional configuration of each of the MFP unit, the server unit, and the panel controller;

FIG. 7 is a diagram showing an example of a copy job screen;

FIG. 8 is a diagram showing an example of a relationship between the copy job screen and a badge row;

FIG. 9 is a diagram showing an example of positions of horizontal slide areas on the copy job screen;

FIG. 10 is a diagram showing an example of a desktop screen;

FIG. 11 is a diagram showing an example of respective positions of a left area, a right area, and a boundary on a display surface and a touch surface;

FIG. 12 is a diagram showing an example of a composite screen;

FIG. 13 is a diagram showing an example of an operation being performed by a user sliding a finger;

FIG. 14 is a flowchart describing an example of an overall process flow of the MFP unit or the server unit;

FIG. 15 is a flowchart describing an example of an overall process flow of the panel controller;

FIG. 16 is a diagram showing an example of displaying a warning icon;

FIG. 17 is a diagram showing an example of sliding a finger in a diagonal direction;

FIG. 18 is a diagram showing an example of sliding a finger from a non-horizontal slide area to a server screen via the horizontal slide area;

FIG. 19 is a diagram showing an example of sliding a finger from the horizontal slide area to the server screen via the non-horizontal slide area;

FIG. 20 is a diagram showing an example of dimming an MFP screen;

FIGS. 21A and 21B are diagrams showing examples of displaying four arranged screens; and

FIG. 22 is a diagram showing an example of gradually narrowing the horizontal slide area.

### DETAILED DESCRIPTION OF EMBODIMENTS

Hereinafter, one or more embodiments of the present invention will be described with reference to the drawings. However, the scope of the invention is not limited to the disclosed embodiments.

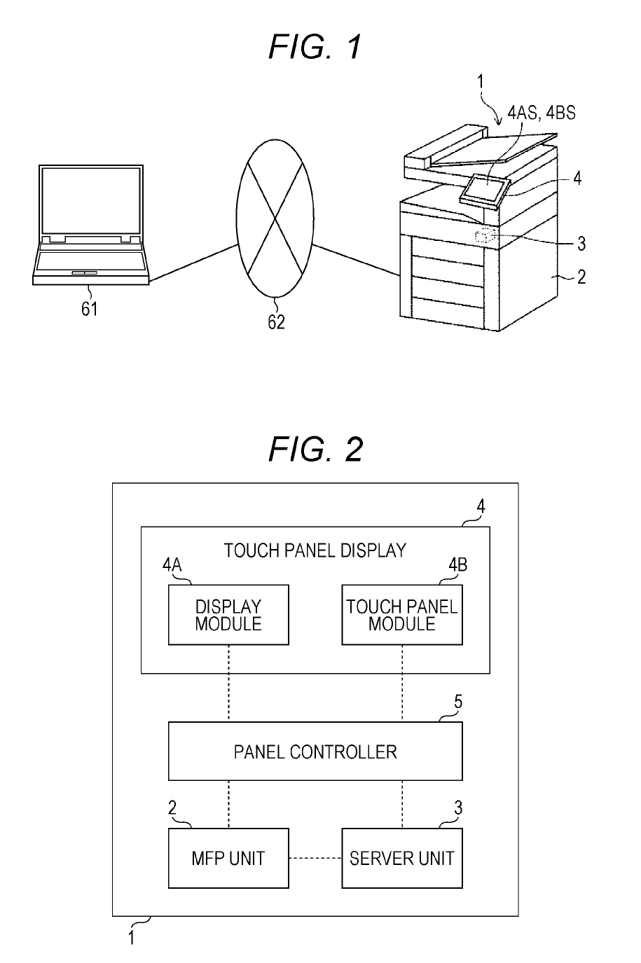

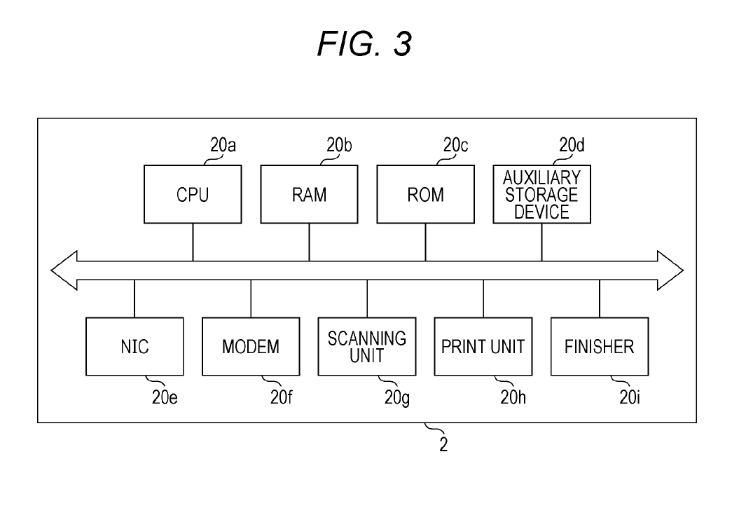

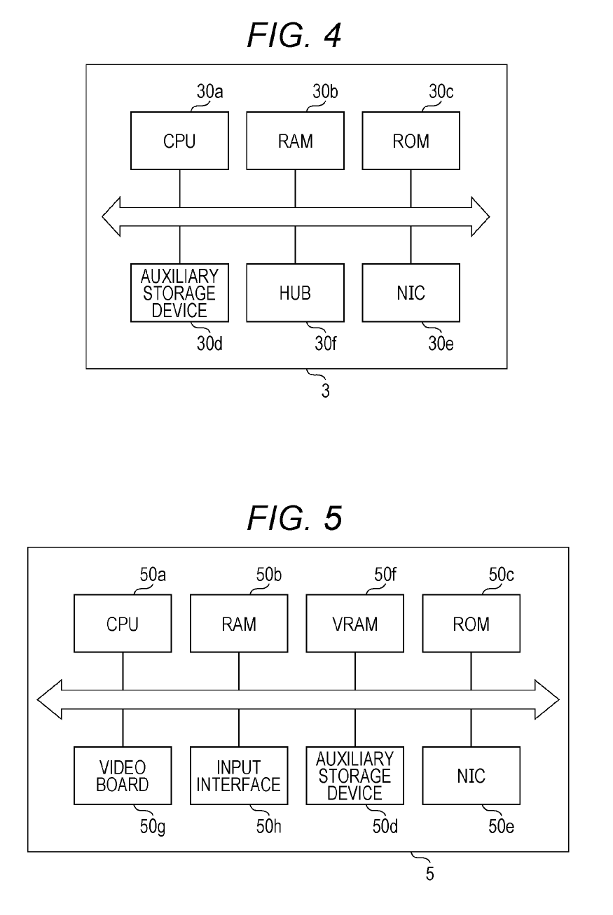

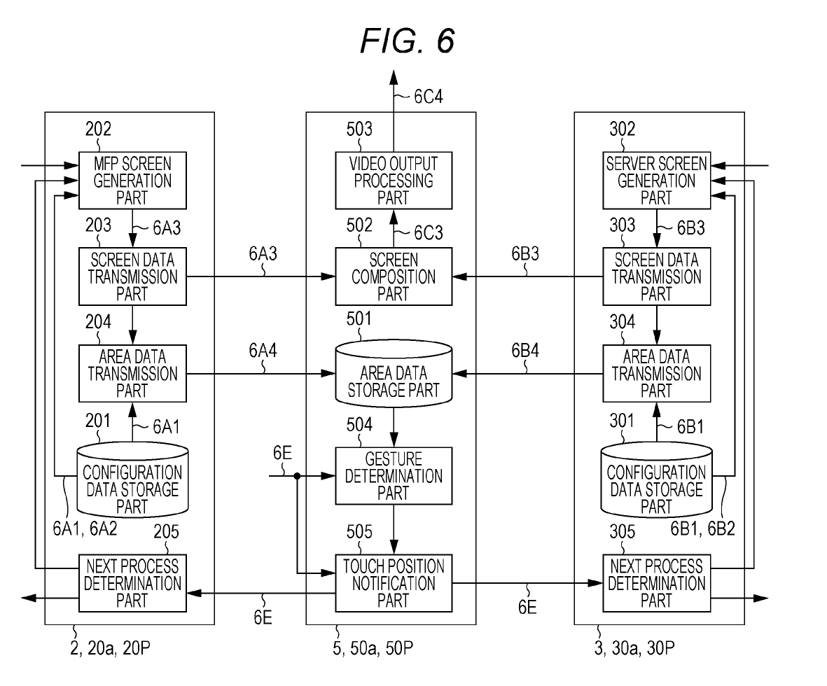

FIG. 1 is a diagram showing an example of a network system including a multifunction machine 1. FIG. 2 is a diagram showing an example of a hardware configuration of the multifunction machine 1. FIG. 3 is a diagram showing an example of a hardware configuration of an MFP unit 2. FIG. 4 is a diagram showing an example of a hardware configuration of a server unit 3. FIG. 5 is a diagram showing an example of a hardware configuration of a panel controller 5. FIG. 6 is a diagram showing an example of a functional configuration of each of the MFP unit 2, the server unit 3, and the panel controller 5.

The multifunction machine 1 shown in FIG. 1 is an apparatus that integrates various functions. The multifunction machine 1 can communicate with a terminal device 61 and the like via a communication line 62. As the communication line 62, there is used the Internet, a local area network (LAN) line, a dedicated line, or the like.

As shown in FIG. 2, the multifunction machine 1 includes the MFP unit 2, the server unit 3, a touch panel display 4, the panel controller 5, and the like.

The server unit 3 is stored in a housing of the MFP unit 2. The touch panel display 4 is disposed at the front of the housing of the multifunction machine 1 such that a display surface 4AS and a touch surface 4BS are substantially horizontal.

The MFP unit 2 is an apparatus corresponding to an image forming apparatus generally referred to as a “multifunction peripheral (MFP)” or the like, and has functions such as a copy function, a PC print function, a facsimile function, a scanning function, and a box function.

The PC print function is a function of printing an image on a paper sheet based on image data received from a device external to the multifunction machine 1 or from the server unit 3.

The box function is a function for providing each user with a storage area referred to as a “box,” “personal box,” or the like, and allowing each user to store and manage image data and the like in the user's own storage area. The box corresponds to a “folder” or “directory” in a personal computer.

The server unit 3 is an apparatus corresponding to a server machine or a personal computer, and has a function as a web server, a file transfer protocol (FTP) server, or the like. As the server unit 3, there is used an embedded computer (for example, embedded Linux (registered trademark) or embedded Windows (registered trademark)). Embedded computers are also referred to as “embedded computer systems,” “built-in servers,” or the like in some cases.

The touch panel display 4 is used in common by the MFP unit 2 and the server unit 3. For a user who directly operates the multifunction machine 1, the touch panel display 4 displays a screen of the MFP unit 2 and a screen of the server unit 3 side by side on the display surface 4AS. In addition, the touch panel display 4 transmits, to the panel controller 5, data representing coordinates of a touch position on the touch surface 4BS.

The panel controller 5 is a computer for causing the MFP unit 2 and the server unit 3 to operate in conjunction with the touch panel display 4. Screen data for displaying a screen are received from the MFP unit 2 or the server unit 3. The panel controller 5 converts the screen data into a video signal, and transmits the video signal to the touch panel display 4. Alternatively, the panel controller 5 generates a composite screen by arranging the respective screens of the MFP unit 2 and the server unit 3, and transmits a video signal for displaying the composite screen to the touch panel display 4. Furthermore, the panel controller 5 transmits the coordinate data received from the touch panel display 4 to the MFP unit 2 or the server unit 3. Alternatively, the panel controller 5 notifies the MFP unit 2 or the server unit 3 of a gesture made by a user.

A basic service is provided to the user based on the respective functions of the MFP unit 2 and the server unit 3. Furthermore, an application service is provided to the user by combination of these functions.

As shown in FIG. 3, the MFP unit 2 includes a central processing unit (CPU) 20a, a random access memory (RAM) 20b, a read-only memory (ROM) 20c, an auxiliary storage device 20d, a network interface card (NIC) 20e, a modem 20f, a scanning unit 20g, a print unit 20h, a finisher 20i, and the like.

The NIC 20e is connected to a hub 30f (see FIG. 4) of the server unit 3 via a twisted pair cable, and communicates with the server unit 3 or the panel controller 5 by using a protocol such as the Transmission Control Protocol/Internet Protocol (TCP/IP). Moreover, the NIC 20e communicates with a device external to the multifunction machine 1, for example, the terminal device 61 or a server on the Internet, via the hub 30f.

The modem 20f exchanges image data with a facsimile terminal by using a protocol such as G3.

The scanning unit 20g generates image data by reading an image drawn on a paper sheet set on a platen glass.

The print unit 20h prints, on a paper sheet, an image represented by image data received from a device external to the multifunction machine 1 or from the server unit 3, in addition to the image read by the scanning unit 20g.

The finisher 20i performs a post-process on printed matter produced by the print unit 20h, as necessary. Examples of the post-process include a stapling process, a process of punching holes, and a folding process.

The CPU 20a is a main CPU of the MFP unit 2. The RAM 20b is a main memory of the MFP unit 2.

The ROM 20c or the auxiliary storage device 20d stores, in addition to an operating system, applications for implementing the above-described functions, such as a copy function, and providing services. Furthermore, a first client program 20P (see FIG. 6) is stored therein. The first client program 20P is a program for receiving a service for sharing the touch panel display 4 with the server unit 3.

These programs are loaded into the RAM 20b to be executed by the CPU 20a. As the auxiliary storage device 20d, there is used a hard disk, a solid state drive (SSD), or the like.

As shown in FIG. 4, the server unit 3 includes a CPU 30a, a RAM 30b, a ROM 30c, an auxiliary storage device 30d, a NIC 30e, the hub 30f, and the like.

The NIC 30e is connected to the hub 30f via a cable, and communicates with a device external to the multifunction machine 1, in addition to the MFP unit 2 and the panel controller 5, via the hub 30f by using a protocol such as the TCP/IP.

As described above, the NIC 30e and the NIC 20e of the MFP unit 2 are connected to the hub 30f via cables. Furthermore, the hub 30f is connected to a router and a NIC 50e (see FIG. 5) of the panel controller 5 via cables. Then, the hub 30f relays data that these devices exchange with one another.

The CPU 30a is a main CPU of the server unit 3. The RAM 30b is a main memory of the server unit 3.

The ROM 30c or the auxiliary storage device 30d stores, in addition to an operating system, a program such as an application for implementing the above-described function or providing a service. Furthermore, a second client program 30P (see FIG. 6) is stored therein. The second client program 30P is a program for receiving a service for sharing the touch panel display 4 with the MFP unit 2.

These programs are loaded into the RAM 30b to be executed by the CPU 30a. As the auxiliary storage device 30d, there is used a hard disk drive, an SSD, or the like.

As shown in FIG. 2, the touch panel display 4 includes a display module 4A, a touch panel module 4B, and the like.

The display module 4A displays a screen based on the video signal transmitted from the panel controller 5. As the display module 4A, there is used a flat panel display such as an organic electro luminescence (EL) display and a liquid crystal display.

Each time the touch panel module 4B detects that the touch surface 4BS has been touched, the touch panel module 4B transmits data representing coordinates of a touch position to the panel controller 5.

As shown in FIG. 5, the panel controller 5 includes a CPU 50a, a RAM 50b, a ROM 50c, an auxiliary storage device 50d, the NIC 50e, a video RAM (VRAM) 50f, a video board 50g, an input interface 50h, and the like.

The NIC 50e is connected to the hub 30f (see FIG. 4) of the server unit 3 via a twisted pair cable, and communicates with the MFP unit 2 or the server unit 3 by using a protocol such as the TCP/IP.

The VRAM 50f is a graphics memory for storing screen data of a screen to be displayed on the touch panel display 4.

The video board 50g converts the screen data into a video signal, and transmits the video signal to the display module 4A. The video board 50g is also referred to as a “graphic board,” “liquid crystal display (LCD) controller,” “video card,” or the like in some cases. There are cases where the VRAM 50f is incorporated in the video board 50g.

Examples of an interface to be used for the video board 50g include the high-definition multimedia interface (HDMI) (registered trademark) and the D-subminiature (D-sub).

The input interface 50h is connected to the touch panel module 4B via a cable, and a signal is input from the touch panel module 4B to the input interface 50h.

Examples of an interface to be used for the input interface 50h include the IEEE 1394 and the universal serial bus (USB).

An operating system and the like are stored in the ROM 50c or the auxiliary storage device 50d. A relay program 50P (see FIG. 6) is stored therein. The relay program 50P is a program for performing a process of combining the screen of the MFP unit 2 and the screen of the server unit 3 and transmitting the combined screens to the display module 4A as a video signal, and a process of notifying either the MFP unit 2 or the server unit 3 of details of an operation performed on the touch panel module 4B.

These programs are loaded into the RAM 50b to be executed by the CPU 50a as necessary. As the auxiliary storage device 50d, there is used a hard disk drive, an SSD, or the like.

The first client program 20P allows, for example, a configuration data storage part 201, an MFP screen generation part 202, a screen data transmission part 203, an area data transmission part 204, and a next process determination part 205 shown in FIG. 6, to be implemented in the MFP unit 2.

The second client program 30P allows, for example, a configuration data storage part 301, a server screen generation part 302, a screen data transmission part 303, an area data transmission part 304, and a next process determination part 305 to be implemented in the server unit 3.

The relay program 50P allows, for example, an area data storage part 501, a screen composition part 502, a video output processing part 503, a gesture determination part 504, and a touch position notification part 505 to be implemented in the panel controller 5.

Each part of the MFP unit 2, each part of the server unit 3, and each part of the panel controller 5 shown in FIG. 6 will be described below while processes are roughly divided into a process for displaying a composite screen and a process for responding to a touch.

[Display of Composite Screen]

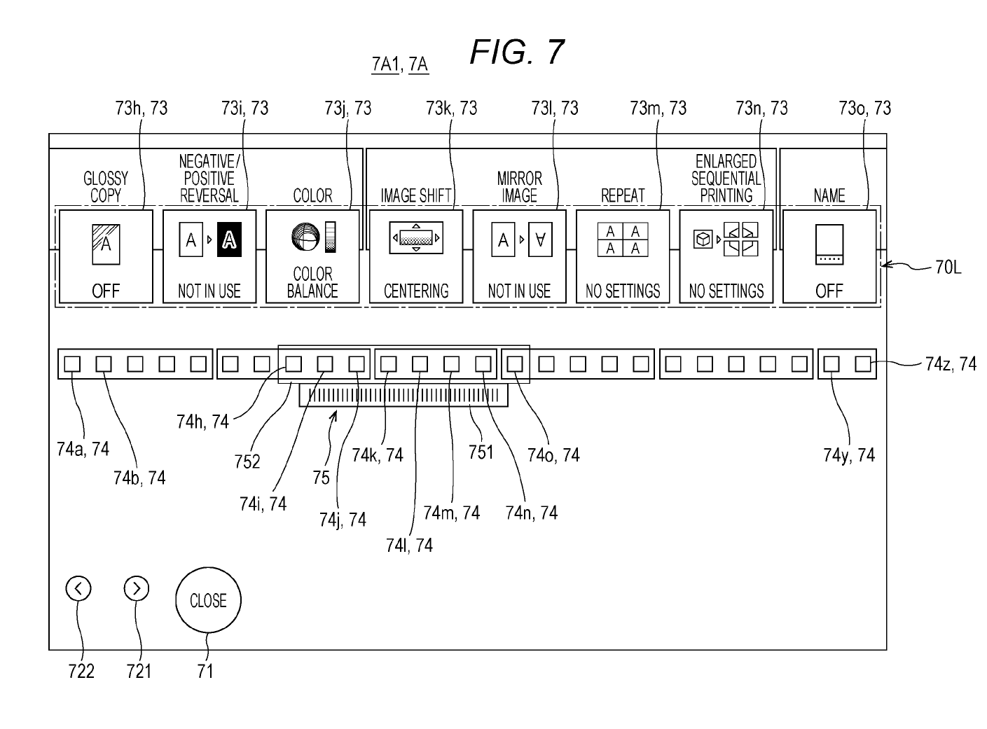

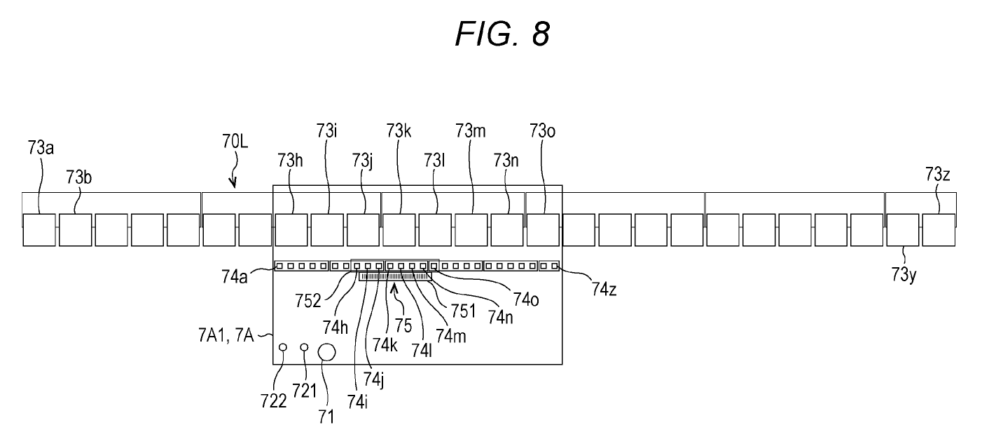

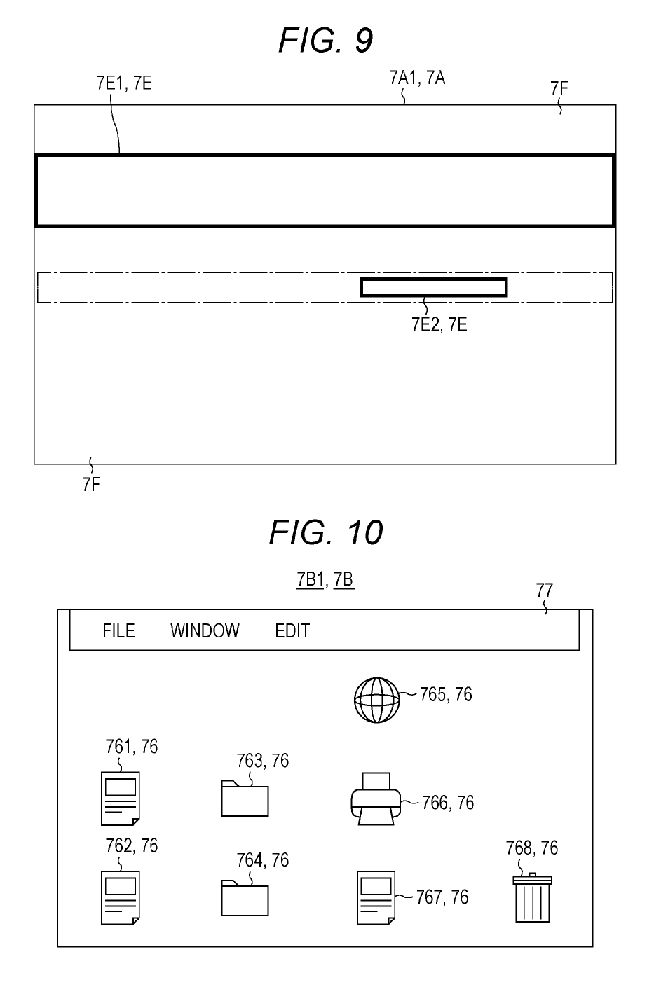

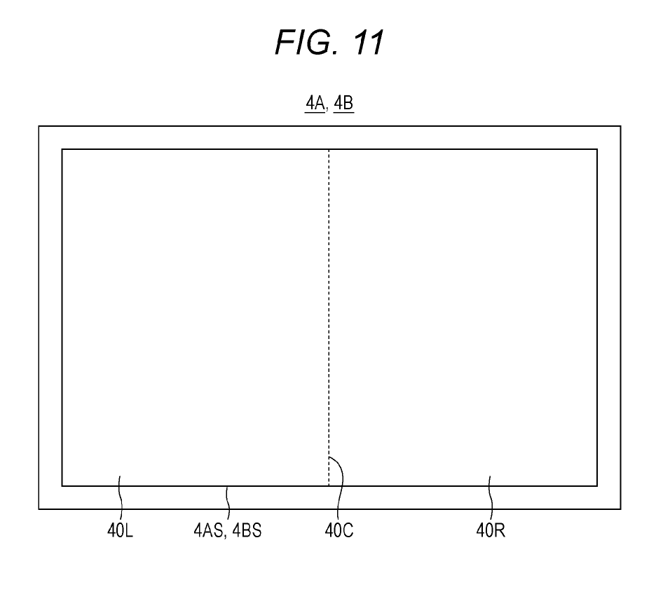

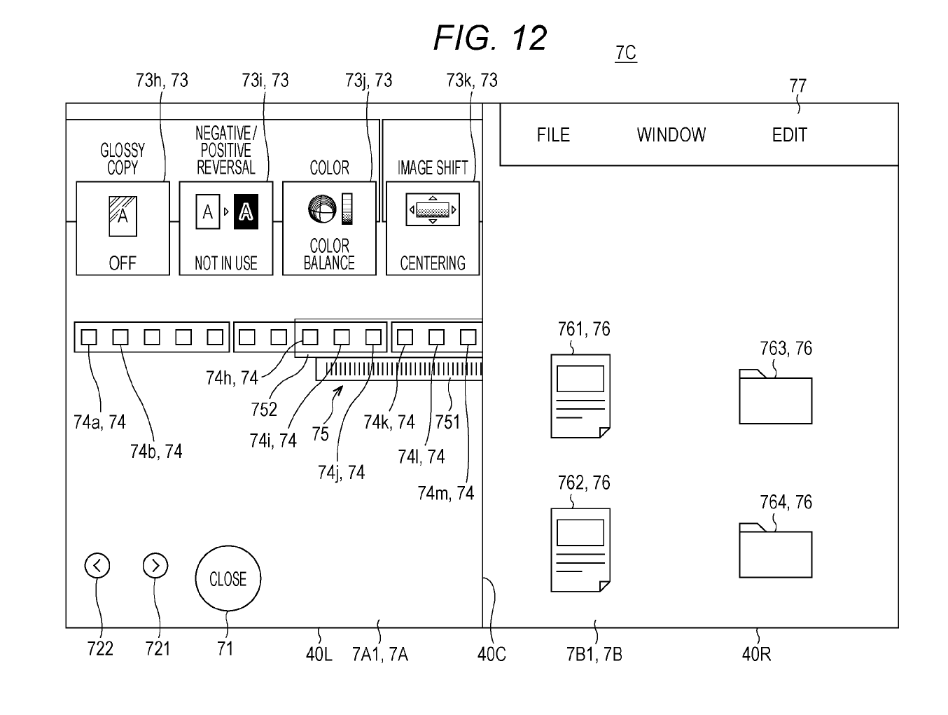

FIG. 7 is a diagram showing an example of a copy job screen 7A1. FIG. 8 is a diagram showing an example of a relationship between the copy job screen 7A1 and a badge row 70L. FIG. 9 is a diagram showing an example of positions of horizontal slide areas 7E1 and 7E2 on the copy job screen 7A1. FIG. 10 is a diagram showing an example of a desktop screen 7B1. FIG. 11 is a diagram showing an example of respective positions of a left area 40L, a right area 40R, and a boundary 40C on the display surface 4AS and the touch surface 4BS. FIG. 12 is a diagram showing an example of a composite screen 7C.

In the MFP unit 2, the configuration data storage part 201 stores in advance screen configuration data 6A1 for each MFP screen 7A that is a screen for a user to operate the MFP unit 2. The screen configuration data 6A1 represent an identifier, a default position, and the like for each object included in the MFP screen 7A. It should be noted that the “default position” is a position with reference to an origin of the MFP screen 7A originally displayed on the display module 4A. A case where the origin is an upper left vertex of the MFP screen 7A will be described below as an example.

For example, on the copy job screen 7A1 which is one of the MFP screens 7A, there are arranged, as objects, a close button 71, a right scroll button 721, a left scroll button 722, a plurality of optional feature badges 73, a plurality of markers 74, a slide gauge 75, and the like as shown in FIG. 7.

The close button 71 is a button for closing the copy job screen 7A1 to display the preceding screen again.

The optional feature badge 73 is an icon representing an optional feature. The one optional feature badge 73 is provided for each optional feature of the MFP unit 2. The optional feature badges 73 are arranged horizontally in a row to form the badge row 70L. However, it is not possible to simultaneously arrange all the optional feature badges 73. That is, as shown in FIG. 8, only some of the optional feature badges 73 are displayed on the copy job screen 7A1, and the other optional feature badges 73 are not displayed thereon.

A user can sequentially display the other optional feature badges 73 by causing the badge row 70L to be scrolled. Hereinafter, the respective optional feature badges 73 will be separately described, in order from left to right, as an “optional feature badge 73a,” an “optional feature badge 73b,”, and an “optional feature badge 73z.”

The right scroll button 721 is a button for scrolling the badge row 70L from right to left. The left scroll button 722 is a button for scrolling the badge row 70L from left to right.

As with the optional feature badges 73, the markers 74 are arranged horizontally in a row. The number of the markers 74 is the same as the number of the optional feature badges 73. In addition, the markers 74 correspond to the respective optional feature badges 73a, 73b, . . . , and 73z in order from left to right. However, all the markers 74 are simultaneously displayed on the copy job screen 7A1. Hereinafter, the markers 74 corresponding to the optional feature badge 73a, the optional feature badge 73b, . . . , and the optional feature badge 73z will be separately described as a “marker 74a,” a “marker 74b,” . . . , and a “marker 74z,” respectively.

The slide gauge 75 includes a slide bar 751 and a window 752. The slide gauge 75 moves to the left or the right according to an operation performed by a user sliding a finger on the slide bar 751, for example, a drag or flick operation.

The window 752 is provided just above the slide bar 751. Furthermore, the markers 74 corresponding to the optional feature badges 73 currently arranged on the copy job screen 7A1 are surrounded by a frame of the window 752.

The window 752 is fixed to the slide bar 751. Therefore, when the slide bar 751 moves, the window 752 moves together therewith. A user can change the markers 74 surrounded by the frame of the window 752 by manipulating the slide bar 751. When the markers 74 surrounded by the frame of the window 752 are changed, the badge row 70L scrolls, and the optional feature badges 73 arranged on the copy job screen 7A1 are changed accordingly.

A user can scroll the badge row 70L by dragging or flicking the badge row 70L, or by tapping the right scroll button 721 or the left scroll button 722. When the badge row 70L scrolls, the slide gauge 75 moves in accordance with a new arrangement of the optional feature badges 73 on the copy job screen 7A1.

Thus, in the copy job screen 7A1, there are an area in which a user can input commands and the like by horizontally sliding a finger and an area in which the user cannot do so. Hereinafter, the former is described as a “horizontal slide area 7E,” and the latter is described as a “non-horizontal slide area 7F.”

Therefore, as shown in FIG. 9, an area in which the badge row 70L is disposed and an area in which the slide bar 751 is disposed are the horizontal slide areas 7E. Hereinafter, the former is described as the “horizontal slide area 7E1,” and the latter is described as the “horizontal slide area 7E2.” A position of the horizontal slide area 7E1 is fixed, while a position of the horizontal slide area 7E2 changes. Areas other than the horizontal slide area 7E1 and the horizontal slide area 7E2 are the non-horizontal slide areas 7F.

Furthermore, the configuration data storage part 201 stores in advance image data 6A2 for each object in association with an identifier.

The MFP screen generation part 202 generates screen data 6A3 for displaying the MFP screen 7A on the display module 4A, based on the screen configuration data 6A1 of the MFP screen 7A and the image data 6A2 of each object included in the MFP screen 7A.

The screen data 6A3 are in, for example, a bitmap format. The screen data 6A3 may be in other formats such as Graphics Interchange Format (GIF) and Joint Photographic Experts Group (JPEG).

It should be noted that the screen configuration data 6A1 and the image data 6A2 are read from the configuration data storage part 201.

The screen data transmission part 203 transmits the screen data 6A3 generated by the MFP screen generation part 202 to the panel controller 5.

Alternatively, the MFP screen generation part 202 may generate moving image data as the screen data 6A3 by drawing the MFP screen 7A at a predetermined frame rate. Then, the screen data transmission part 203 transmits the screen data 6A3 to the panel controller 5 through live streaming. A case where the MFP screen 7A is drawn at a predetermined frame rate will be described below as an example. The same applies to screen data 6B3 to be described below.

When the screen data transmission part 203 starts to transmit the new screen data 6A3 of the MFP screen 7A, the area data transmission part 204 transmits, to the panel controller 5, area data 6A4 representing a current position of each of the horizontal slide areas 7E in the MFP screen 7A. However, if there is no horizontal slide area 7E in the MFP screen 7A, the area data 6A4 are not transmitted.

In the server unit 3, the configuration data storage part 301 stores in advance screen configuration data 6B1 for each server screen 7B that is a screen for a user to operate the server unit 3. The screen configuration data 6B1 represent an identifier, a default position, and the like for each object included in the server screen 7B. It should be noted that the “default position” is a position with reference to an origin of the server screen 7B originally displayed on the display module 4A. A case where the origin is an upper left vertex of the server screen 7B will be described below as an example.

For example, as shown in FIG. 10, objects such as a menu bar 77 and a plurality of icons 76 are arranged on the desktop screen 7B1 which is one of the server screens 7B. For the sake of simplicity of description, a case where the horizontal slide area 7E is not provided on the desktop screen 7B1 will be described below as an example.

Furthermore, the configuration data storage part 301 stores in advance image data 6B2 for each object in association with an identifier.

The server screen generation part 302 generates the screen data 6B3 for displaying the server screen 7B on the display module 4A, based on the screen configuration data 6B1 of the server screen 7B and the image data 6B2 of each object included in the server screen 7B. It should be noted that the screen configuration data 6B1 and the image data 6B2 are read from the configuration data storage part 301.

The screen data transmission part 303 transmits the screen data 6B3 generated by the server screen generation part 302 to the panel controller 5.

When the screen data transmission part 303 starts to transmit the new screen data 6B3 of the server screen 7B, the area data transmission part 304 transmits, to the panel controller 5, area data 6B4 representing a current position of each of the horizontal slide areas 7E in the server screen 7B. However, if there is no horizontal slide area 7E in the server screen 7B, the area data 6B4 are not transmitted.

Meanwhile, as shown in FIG. 11, the display surface 4AS of the display module 4A and the touch surface 4BS of the touch panel module 4B are equally divided, by the boundary 40C, into two areas on the left and right. As a rule, the left area 40L, which is the area on the left side, is used for display or operation of the MFP screen 7A. As a rule, the right area 40R, which is the area on the right side, is used for display and operation of the server screen 7B.

It should be noted that in the present embodiment, dimensions (height and width) of each of the MFP screens 7A are determined in advance such that the dimensions are common to all the MFP screens 7A. The dimensions of the MFP screens 7A are the same as those of the display surface 4AS of the display module 4A. The same applies to the server screen 7B. Furthermore, for the sake of simplicity of description, a case where a resolution of the display surface 4AS is the same as a resolution of the touch surface 4BS of the touch panel module 4B will be described as an example. Moreover, on each of the display surface 4AS, the touch surface 4BS, the MFP screen 7A, and the server screen 7B, an upper left vertex is defined as an origin, a vertical axis is defined as a y-axis, and a horizontal axis is defined as an x-axis.

In the panel controller 5, the area data storage part 501 stores the screen configuration data 6A1 transmitted from the MFP unit 2 and the screen configuration data 6B1 transmitted from the server unit 3.

The screen composition part 502 generates screen data 6C3 of the composite screen 7C based on the screen data 6A3 received from the MFP unit 2 and the screen data 6B3 received from the server unit 3. As shown in FIG. 12, respective left halves of the MFP screen 7A and the server screen 7B are combined and arranged side by side on the composite screen 7C.

A case of combining the copy job screen 7A1 shown in FIG. 7 and the desktop screen 7B1 shown in FIG. 10 will be described below as an example.

When the screen composition part 502 generates the screen data 6C3, the video output processing part 503 causes the video board 50g to perform a process of converting the screen data 6C3 into a video signal 6C4 and outputting the video signal 6C4 to the display module 4A.

Then, the display module 4A displays the composite screen 7C based on the video signal 6C4.

[Process for Responding to Touch]

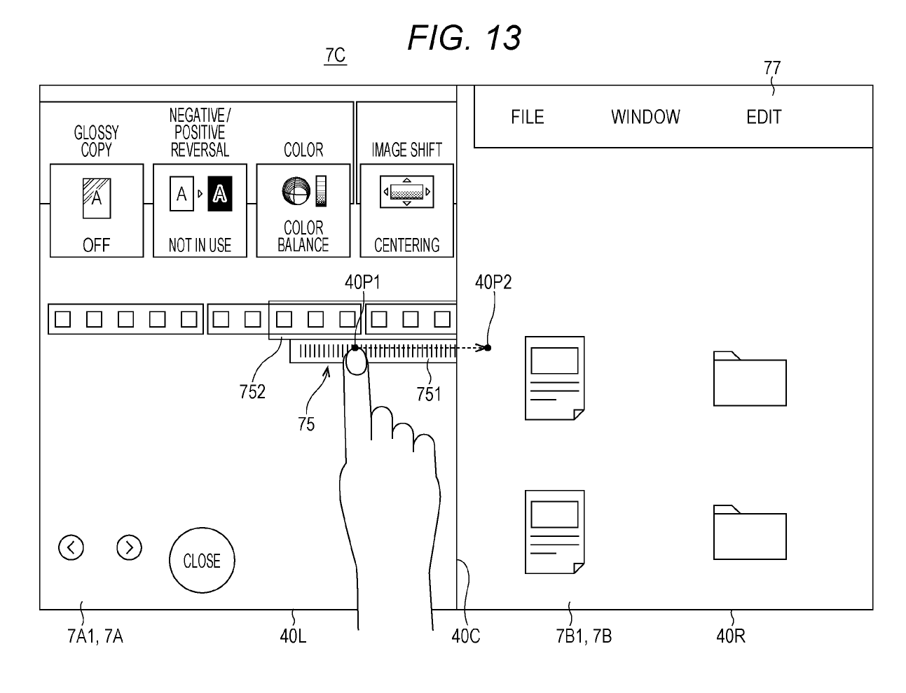

FIG. 13 is a diagram showing an example of an operation being performed by a user sliding a finger.

While the touch surface 4BS is being touched, the touch panel module 4B transmits, to the panel controller 5, coordinate data 6E representing coordinates of a touch position at regular intervals, for example, at intervals of 0.1 seconds.

When the coordinate data 6E starts to be received, the gesture determination part 504 determines a type of a gesture made by a user (hereinafter described as a “user gesture”), based on the coordinate data 6E as follows. The gesture determination part 504 determines that the user gesture is a double tap in the following case. The coordinate data 6E representing the same coordinates are received only once or consecutively within a predetermined period of time Ta, and then, after a predetermined interval Tb, the coordinate data 6E representing the same coordinates are received again only once or consecutively within the predetermined period of time Ta.

As another example, the gesture determination part 504 determines that the user gesture is a flick in the case where a change in coordinates represented by the respective coordinate data 6E consecutively received is seen in a definite direction at a speed equal to or more than a predetermined speed Sa. In the case where the speed of the change is less than the predetermined speed Sa, it is determined that the user gesture is a drag operation.

It should be noted that these methods of determining the types of user gestures are merely examples, and other methods may be used.

The touch position notification part 505 transmits the coordinate data 6E received from the panel controller 5 to either the MFP unit 2 or the server unit 3 according to, for example, the result of determination by the gesture determination part 504 as follows.

When the gesture determination part 504 determines that the user gesture is a gesture made without sliding a finger (for example, a tap or double tap), the touch position notification part 505 transmits the received coordinate data 6E to the MFP unit 2 if coordinates represented by the coordinate data 6E belong to the left area 40L. Meanwhile, if the coordinates belong to the right area 40R, the touch position notification part 505 transmits the received coordinate data 6E to the server unit 3.

Incidentally, the coordinates are those with reference to an origin of the touch surface 4BS, and neither those with reference to an origin of the copy job screen 7A1 nor those with reference to an origin of the desktop screen 7B1. However, the origin of the touch surface 4BS coincides with the origin of the copy job screen 7A1. The origin of the touch surface 4BS does not coincide with the origin of the desktop screen 7B1.

Therefore, when the coordinates belong to the right area 40R, the touch position notification part 505 corrects the coordinates so that the coordinates are changed to coordinates with reference to the origin of the server screen 7B, and transmits the coordinate data 6E to the server unit 3. Specifically, the coordinates are shifted to the left by a width of the left area 40L. That is, a value of the width of the left area 40L is subtracted from an x-coordinate of the coordinates. Hereinafter, a process of thus correcting coordinates on the touch surface 4BS so that the coordinates are changed to coordinates on the server screen 7B is described as a “shift process.”

Alternatively, when the gesture determination part 504 determines that the user gesture is a gesture of sliding a finger (for example, flicking or dragging), the touch position notification part 505 determines whether the coordinates represented by the first coordinate data 6E received belong to the horizontal slide area 7E based on the area data 6A4 stored in the area data storage part 501 if the coordinates belong to the left area 40L.

Then, if it is determined that the coordinates belong to the horizontal slide area 7E, the gesture determination part 504 sequentially transmits, to the MFP unit 2, a series of the coordinate data 6E relating to the user gesture, that is, the coordinate data 6E consecutively received. Even if coordinates belonging to the right area 40R are represented by any of the coordinate data 6E, the gesture determination part 504 transmits the series of the coordinate data 6E to the MFP unit 2.

Even when, for example, the slide bar 751 is flicked or dragged from the left area 40L to the right area 40R as shown in FIG. 13, transmission of the coordinate data 6E in the above-described manner allows, among the coordinate data 6E, not only the coordinate data 6E of a point touched before the boundary 40C is crossed but also the coordinate data 6E of a point touched after the boundary 40C is crossed, to be transmitted to the MFP unit 2.

In the MFP unit 2, the next process determination part 205 determines a process to be performed next (hereinafter described as a “next process”) based on the coordinate data 6E transmitted from the panel controller 5. Then, the next process is performed in the MFP unit 2.

Similarly, in the server unit 3, the next process determination part 305 determines a next process based on the coordinate data 6E transmitted from the panel controller 5. Then, the next process is performed.

Even in the case where flicking or dragging is performed across the boundary 40C as shown in FIG. 13, if the flicking or dragging is started in the horizontal slide area 7E, not only the coordinate data 6E of a point touched before the boundary 40C is crossed but also the coordinate data 6E of a point touched after the boundary 40C is crossed are transmitted to the MFP unit 2. Therefore, a next process is determined and performed in accordance with not a distance from a starting point 40P1 of the flicking or dragging to the boundary 40C, but a distance from the starting point 40P1 to an ending point 40P2.

However, if the flicking or dragging is started in the non-horizontal slide area 7F, the coordinate data 6E of a point touched before the boundary 40C is crossed are transmitted to the MFP unit 2, while the coordinate data 6E of a point touched after the boundary 40C is crossed are transmitted to the server unit 3. Therefore, the next process determination part 305 recognizes that swipe-in has been performed from a left end of the server screen 7B, and determines that a process corresponding to the swipe-in (for example, a process of displaying a menu) should be a next process.

It should be noted that in the case where it is necessary to change a configuration of the MFP screen 7A when performing the next process, the screen configuration data 6A1 of the MFP screen 7A are updated according to the change. Then, the screen data 6A3 are generated by the MFP screen generation part 202 based on the updated screen configuration data 6A1. Alternatively, in the case where it is necessary to change the MFP screen 7A to another MFP screen 7A, the screen data 6A3 are generated by the MFP screen generation part 202 based on the screen configuration data 6A1 of the other MFP screen 7A. Similarly, in the server unit 3, the server screen 7B is updated or changed to another server screen 7B.

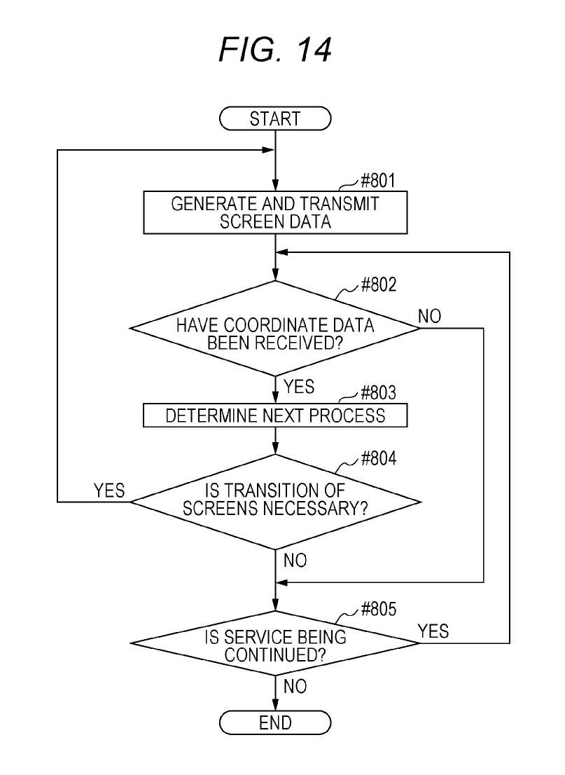

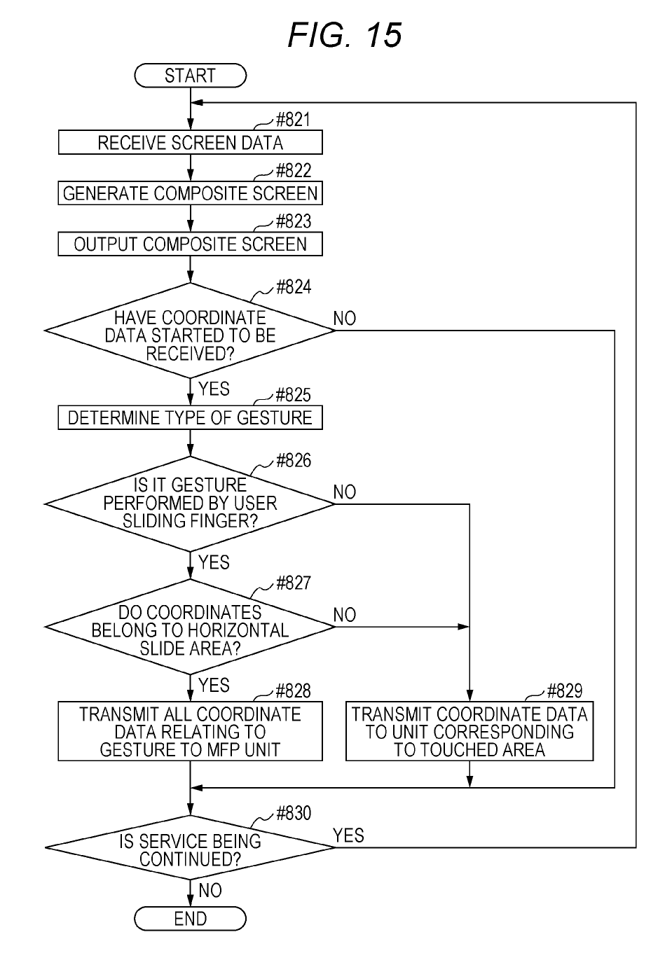

FIG. 14 is a flowchart describing an example of an overall process flow of the MFP unit 2 or the server unit 3. FIG. 15 is a flowchart describing an example of an overall process flow of the panel controller 5.

Next, the overall process flow of each of the MFP unit 2, the server unit 3, and the panel controller 5 will be described with reference to the flowcharts.

The MFP unit 2 performs a process based on the first client program 20P in accordance with a procedure shown in FIG. 14. The server unit 3 performs a process based on the second client program 30P in accordance with the procedure shown in FIG. 14. That is, the overall process flow of the MFP unit 2 is basically the same as the overall process flow of the server unit 3.

The panel controller 5 performs a process based on the relay program 50P in accordance with a procedure shown in FIG. 15.

After starting the operating system, the MFP unit 2 starts generation of the screen data 6A3 of a predetermined MFP screen 7A (for example, the copy job screen 7A1 shown in FIG. 7) and transmission of the screen data 6A3 to the panel controller 5 (#801 in FIG. 14).

After starting the operating system, the server unit 3 starts generation of the screen data 6B3 of a predetermined server screen 7B (for example, the desktop screen 7B1 shown in FIG. 10) and transmission of the screen data 6B3 to the panel controller 5 (#801).

Upon receiving the screen data 6A3 and the screen data 6B 3 (#821 in FIG. 15), the panel controller 5 generates the screen data 6C3 of the composite screen 7C as shown in FIG. 12 (#822). Then, the panel controller 5 converts the screen data 6C3 into the video signal 6C4, and outputs the video signal 6C4 to the display module 4A (#823). As a result, the composite screen 7C is displayed by the display module 4A.

While a gesture is being made by a user touching the touch surface 4BS, data representing a point being touched are transmitted, as the coordinate data 6E, from the touch panel module 4B to the panel controller 5 at regular intervals.

Upon starting to receive the coordinate data 6E (Yes in #824), the panel controller 5 determines a type of the gesture made by the user, that is, a type of the user gesture made by the user (#825).

The panel controller 5 transmits a series of the coordinate data 6E relating to the user gesture to the MFP unit 2 (#828) in the case where the user gesture is a gesture made by the user sliding a finger, such as dragging or flicking (Yes in #826), coordinates represented by the first coordinate data 6E belong to the left area 40L, that is, the user gesture has been started in the left area 40L, and the coordinates belong to the horizontal slide area 7E (Yes in #827).

In the case where the user gesture is not a gesture made by the user sliding a finger (No in #826), the panel controller 5 transmits each of the received coordinate data 6E to the MFP unit 2 or the server unit 3 in accordance with the coordinates represented by the coordinate data 6E (#829). That is, if the coordinates belong to the left area 40L, the coordinate data 6E are transmitted to the MFP unit 2. If the coordinates belong to the right area 40R, the coordinate data 6E are transmitted to the server unit 3 after being subjected to the shift process. Transmission is similarly performed (#829) also in the case where the user gesture is a gesture made by the user sliding a finger (Yes in #826), while the coordinates represented by the first coordinate data 6E belong to the right area 40R or the non-horizontal slide area 7F of the MFP screen 7A (No in #827).

Upon receiving the coordinate data 6E from the panel controller 5 (Yes in #802), the MFP unit 2 determines a next process (#803). Then, the next process is performed in the MFP unit 2. If it is necessary for the MFP screen 7A to shift from one screen to another in the next process (Yes in #804), the process returns to step #801 so as to generate the screen data 6A3 of the MFP screen 7A with a new configuration and start to transmit the screen data 6A3 to the panel controller 5. Alternatively, the MFP unit 2 generates the screen data 6A3 of the new MFP screen 7A, and starts to transmit the screen data 6A3 to the panel controller 5.

Similarly, upon receiving the coordinate data 6E from the panel controller 5 (Yes in #802), the server unit 3 also determines a next process (#803). Then, the process returns to step #801, as appropriate, so as to perform a process for causing the server screen 7B to shift from one screen to another.

While the service implemented by the first client program 20P is continuing (Yes in #805), the MFP unit 2 performs steps #801 to #804 as appropriate. Similarly, while the service implemented by the second client program 30P is continuing (Yes in #805), the server unit 3 also performs the above-described steps as appropriate.

While the service implemented by the relay program 50P is continuing (Yes in #830), the panel controller 5 performs steps #821 to #829 as appropriate.

According to the present embodiment, even when the MFP screen 7A and the server screen 7B are displayed side by side, operability of the MFP screen 7A and the server screen 7B can be further improved as compared with the conventional techniques.

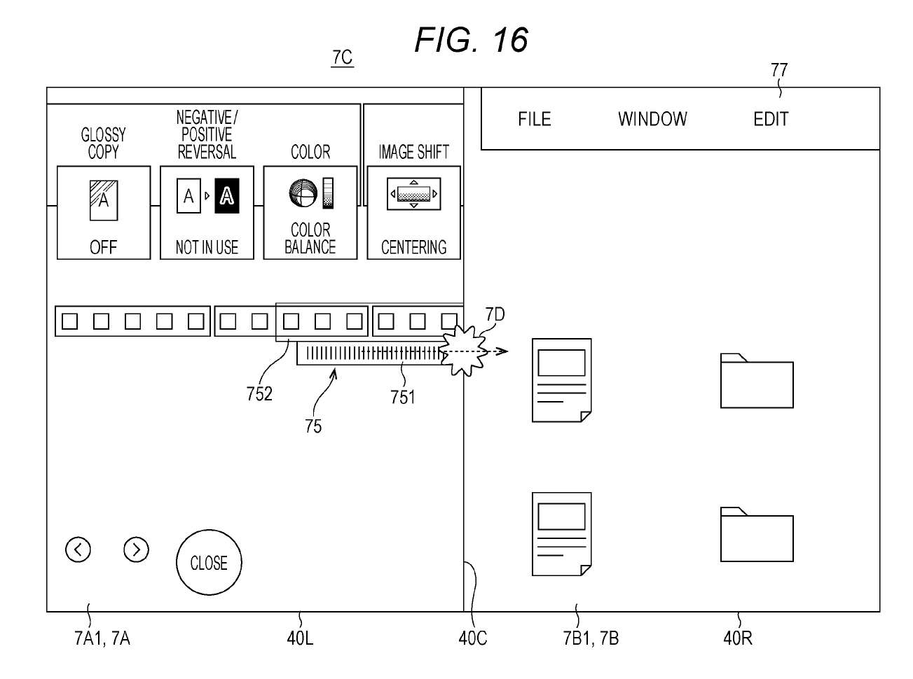

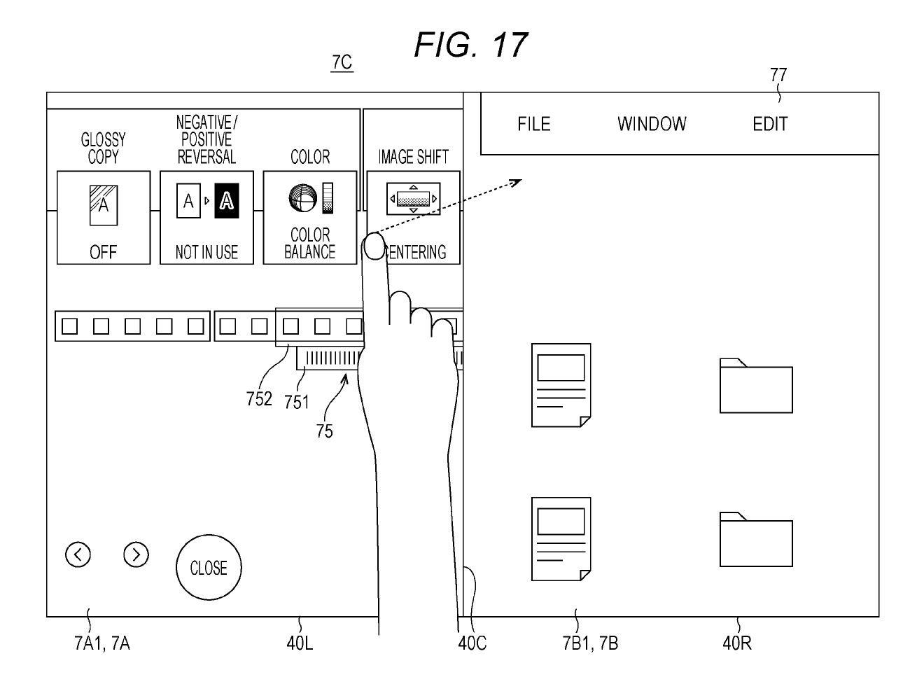

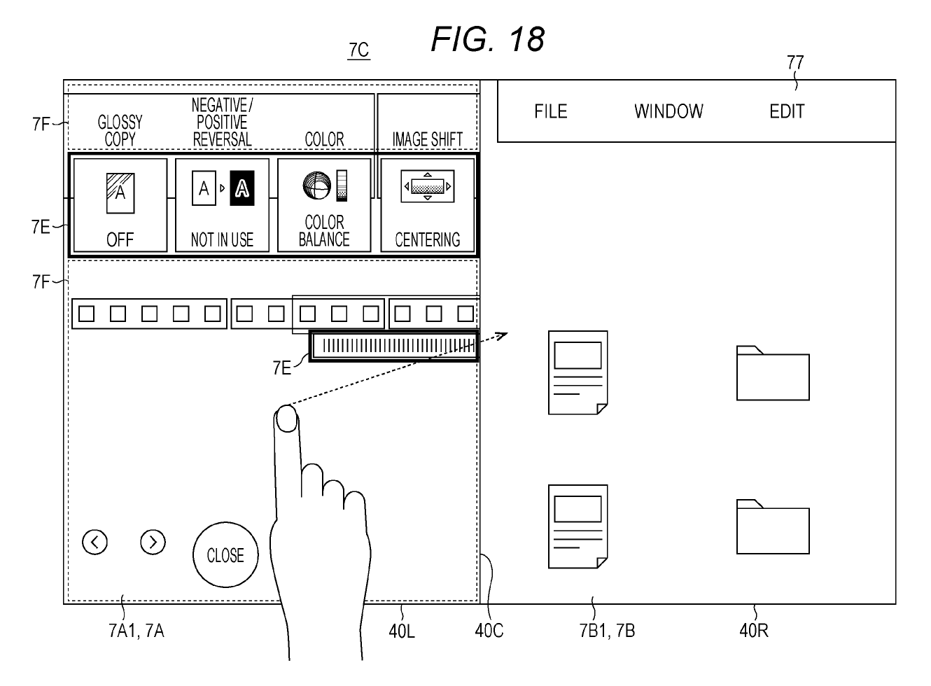

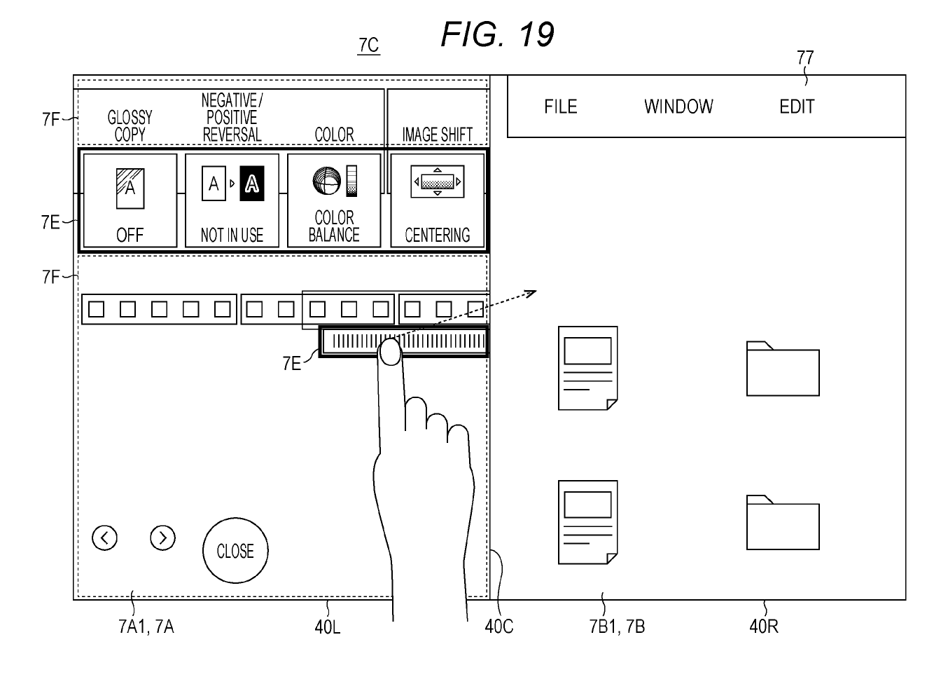

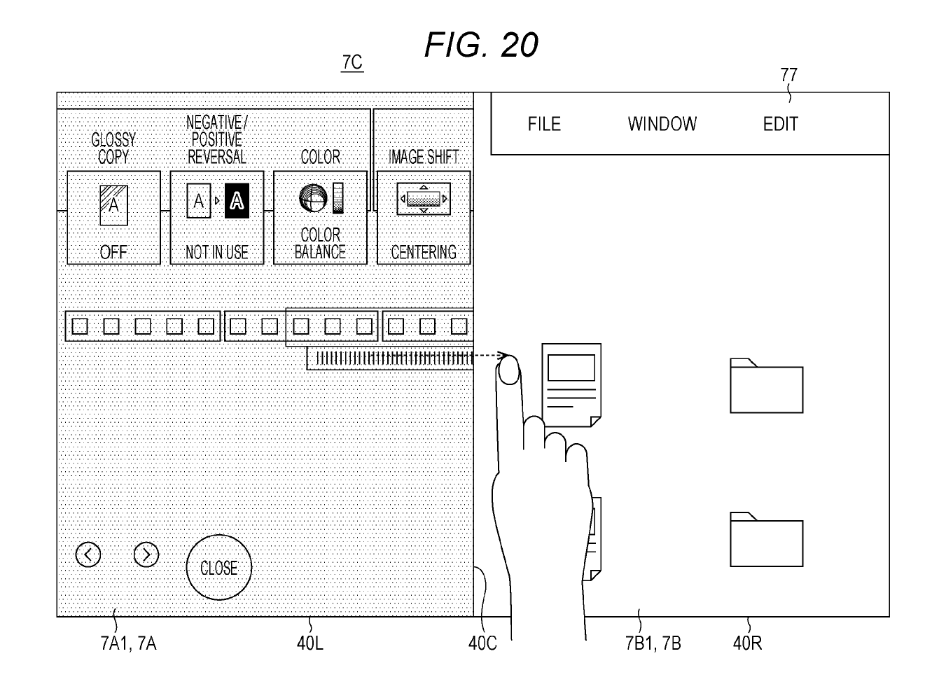

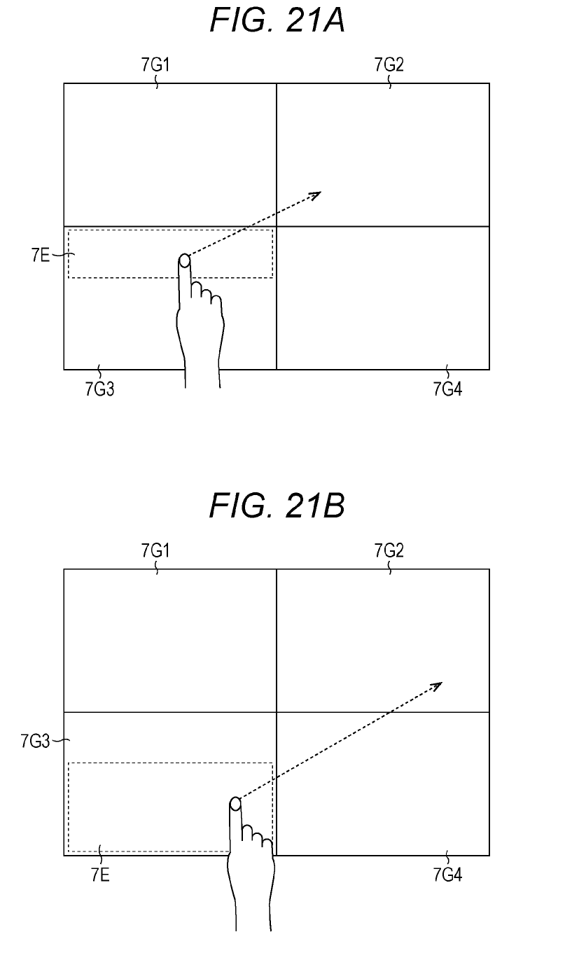

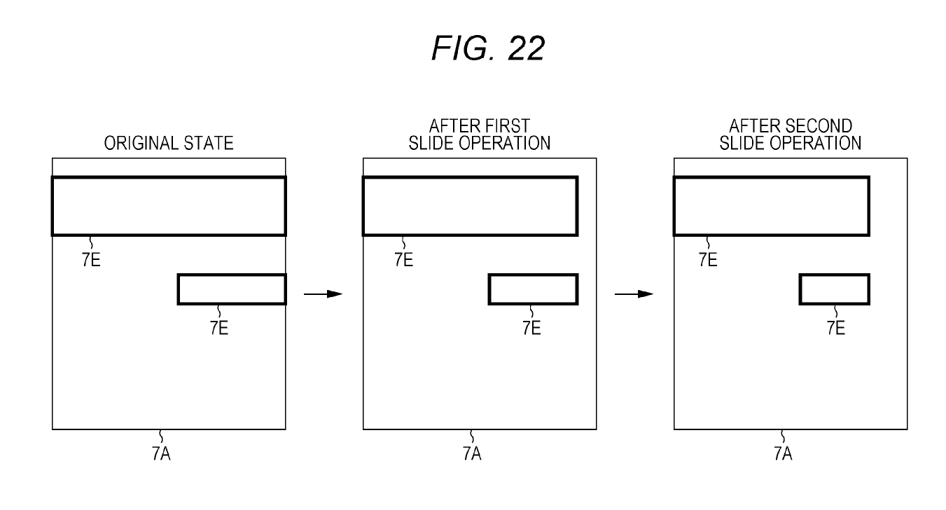

FIG. 16 is a diagram showing an example of displaying a warning icon 7D. FIG. 17 is a diagram showing an example of sliding a finger in a diagonal direction. FIG. 18 is a diagram showing an example of sliding a finger from the non-horizontal slide area 7F to the server screen 7B via the horizontal slide area 7E. FIG. 19 is a diagram showing an example of sliding a finger from the horizontal slide area 7E to the server screen 7B via the non-horizontal slide area 7F. FIG. 20 is a diagram showing an example of dimming the MFP screen 7A. FIGS. 21A and 21B are diagrams showing examples of displaying four arranged screens. FIG. 22 is a diagram showing an example of gradually narrowing the horizontal slide area 7E.

In the present embodiment, an area in which a user can perform dragging or flicking to the left and dragging or flicking to the right is used as the horizontal slide area 7E. Meanwhile, it is also possible to use, as the horizontal slide area 7E, an area in which a user can perform, of dragging or flicking in the two directions, only dragging or flicking to the right, that is, dragging or flicking from the MFP screen 7A to the server screen 7B.

In the present embodiment, when a finger enters the server screen 7B from the horizontal slide area 7E at the time of flicking or dragging, the touch position notification part 505 transmits the coordinate data 6E to the MFP unit 2, and does not transmit the coordinate data 6E to the server unit 3. As a result, the flicking or dragging is treated as an operation on the MFP screen 7A. However, originally, it is not preferable that an operation on the MFP screen 7A extends to the server screen 7B.

Therefore, in such a case, the screen composition part 502 may generate the screen data 6C3 of the composite screen 7C including the warning icon 7D superimposed on the boundary 40C as shown in FIG. 16. Then, the display module 4A displays the composite screen 7C in this state. Alternatively, an object flicked or dragged may be blinked. For example, when a right end of the slide bar 751 is flicked or dragged, the right end of the slide bar 751 may be blinked. Alternatively, the screen composition part 502 may cause a speaker to output a warning sound.

There are cases where a user performs a flick or drag operation twice consecutively, and a finger enters the server screen 7B from the horizontal slide area 7E in both of the two consecutive flick or drag operations. According to the present embodiment, for both of the two consecutive flick or drag operations in this case, the touch position notification part 505 of the panel controller 5 transmits, to the MFP unit 2, the coordinate data 6E generated by the touch panel module 4B while the flick or drag operations are being performed.

However, in this case, if a time interval between first flicking or dragging and second flicking or dragging is less than a predetermined period of time T1 (for example, 5 seconds), the touch position notification part 505 may recognize the second flicking or dragging as swipe-in to the server screen 7B, and transmit the coordinate data 6E to the server unit 3 after the boundary 40C is crossed. Before the boundary 40C is crossed, it is not necessary to transmit the coordinate data 6E to either the MFP unit 2 or the server unit 3.

Incidentally, it is also possible to recognize the second flicking or dragging as swipe-in to the server screen 7B only when a distance between a starting point of the second flicking or dragging and the boundary 40C is less than a predetermined distance L1. The predetermined distance L1 is approximately equal to, for example, a width of a finger, that is, 1 to 2 centimeters.

Similarly, in the case where third flicking or dragging is performed within the predetermined period of time T1 after the second flicking or dragging, the touch position notification part 505 may recognize the third flicking or dragging as swipe-in to the server screen 7B. The same applies to fourth and subsequent flicking or dragging.

However, in the case where another gesture is made between Nth flicking or dragging and (N+1)th flicking or dragging, the touch position notification part 505 does not regard the (N+1)th flicking or dragging as swipe-in to the server screen 7B. Then, the touch position notification part 505 transmits the coordinate data 6E to the MFP unit 2 or the server unit 3 according to the other gesture.

Alternatively, assume that a period of time for which a finger is slid on the horizontal slide area 7E of the MFP screen 7A exceeds a predetermined period of time. In such a case, even if flicking or dragging is the second or subsequent one, and the finger subsequently enters the server screen 7B, the touch position notification part 505 may regard the flicking or dragging as an operation in the horizontal slide area 7E, and continue to transmit the coordinate data 6E to the MFP unit 2.

Similarly, in the case where flicking or dragging is performed within the predetermined period of time T1 after tapping is performed in the non-horizontal slide area 7F, and a finger enters the server screen 7B from the MFP screen 7A at this time, the touch position notification part 505 may regard the flicking or dragging as swipe-in to the server screen 7B, and transmit the coordinate data 6E to the server unit 3 after the boundary 40C is crossed.

A user may slide a finger horizontally in some cases, and may slide it diagonally as shown in FIG. 17 in other cases. In the latter case, if a finger moves at a predetermined angle (for example, 30 degrees) to the x-axis, and the next process determination part 205 determines that a next process should be a process of causing the MFP screen 7A to be horizontally scrolled, the MFP screen generation part 202 may scroll the MFP screen 7A by an amount of change in the horizontal direction (that is, an amount of change in an x component), not based on an amount of change in the vertical direction (that is, an amount of change in a y component). Similarly, if the next process determination part 305 in the server unit 3 determines that a next process should be a process corresponding to swipe-in, the next process may be performed based not on the amount of change in the vertical direction, but on the amount of change in the horizontal direction. The predetermined angle can be arbitrarily set by the user.

There are cases where flicking or dragging starts from the non-horizontal slide area 7F, and ends on the server screen 7B via an object in the horizontal slide area 7E as shown in FIG. 18. In this case, the touch position notification part 505 may transmit, to the MFP unit 2, all the coordinate data 6E obtained from the touch panel module 4B during the flicking or dragging. Then, in the MFP unit 2, the next process determination part 205 may determine a next process by considering that the flicking or dragging has been performed on the object from the actual starting point, or considering that the flicking or dragging has been performed from a position at which a finger has reached the object.

Alternatively, there are cases where flicking or dragging starts from an object in the horizontal slide area 7E, and ends on the server screen 7B via the non-horizontal slide area 7F as shown in FIG. 19. In this case, the next process determination part 205 can determine a next process based on the coordinate data 6E regarding positions between a position from which the flicking or dragging starts and a position at which a finger reaches the non-horizontal slide area 7F.

While the touch position notification part 505 is transmitting the coordinate data 6E to the server unit 3 after recognizing flicking or dragging as swipe-in to the server screen 7B, the screen composition part 502 may generate the screen data 6C3 of the composite screen 7C in which brightness of the MFP screen 7A is lower than normal (that is, the MFP screen 7A is dimmed) as shown in FIG. 20. Then, the display module 4A displays the composite screen 7C in this state.

In the case where a touch on the MFP screen 7A or the server screen 7B continues for a certain period of time or longer, the touch position notification part 505 may consider that the touch has been ended, and terminate transmission of the coordinate data 6E to the MFP unit 2 or the server unit 3. Alternatively, in this case, the next process determination part 205 or the next process determination part 305 may stop determining a next process corresponding to a gesture made while the touch is given.

In the case where the server screen 7B starts to be touched while the MFP screen 7A is being touched, the touch position notification part 505 may stop transmitting the coordinate data 6E to the MFP unit 2.

There are cases where three or more screens are displayed on the display module 4A. For example, there are cases where a first screen 7G1, a second screen 7G2, a third screen 7G3, and a fourth screen 7G4 are arranged and displayed on the display module 4A, as shown in FIGS. 21A and 21B.

In the case where a user slides a finger across three or four screens of these four screens, the touch position notification part 505 transmits the coordinate data 6E obtained from the touch panel module 4B while the user is sliding the finger, as follows.

For example, in the case where a slide operation starts from the horizontal slide area 7E in the third screen 7G3 as shown in FIG. 21A, the touch position notification part 505 transmits the coordinate data 6E to either the MFP unit 2 or the server unit 3, corresponding to a unit having the third screen 7G3, regardless of a screen across which the user subsequently slides the finger.

Alternatively, assume that a slide operation starts from the non-horizontal slide area 7F in the third screen 7G3, and ends on the second screen 7G2 via the fourth screen 7G4, as shown in FIG. 21B. In this case, the touch position notification part 505 recognizes that the slide operation is swipe-in to the second screen 7G2, that is, a screen on which the slide operation is ended, and transmits the coordinate data 6E to a unit having the second screen 7G2. Alternatively, the touch position notification part 505 may recognize that the slide operation has been performed on a screen (the fourth screen 7G4 in the present example) on which the finger has traveled a distance that is longest of distances traveled on these screens, and may transmit the coordinate data 6E to a unit having the screen.

In the present embodiment, even in the case where a finger enters the server screen 7B from the horizontal slide area 7E, the touch position notification part 505 regards movement of the finger as dragging or flicking in the horizontal slide area 7E, and transmits the coordinate data 6E to the MFP unit 2 even after the finger enters the server screen 7B. However, the touch position notification part 505 may regard the movement of the finger as swipe-in to the server screen 7B, and transmit the coordinate data 6E to the server unit 3 after a predetermined period of time (for example, 2 to 5 seconds) after the finger enters the server screen 7B.

In the case where the horizontal slide area 7E is flicked or dragged consecutively a predetermined number of times (for example, three times) or more within a predetermined period of time (for example, 3 to 15 seconds), the gesture determination part 504 may gradually narrow a range of the horizontal slide area 7E as shown in FIG. 22 so that swipe-in can be preferentially accepted. In this case, the screen composition part 502 may visualize the horizontal slide area 7E by, for example, causing a color of the horizontal slide area 7E to be distinguishable from colors of other areas.

In the case of dragging or flicking an object which is used by being tapped, such as a button and an icon, the gesture determination part 504 may constantly determine that the dragging or flicking is not swipe-in to the server screen 7B, but a gesture intended for the object even if a finger enters the server screen 7B.

Assume that horizontal dragging or flicking of an object is invalid, while vertical dragging or flicking of the object is valid. In the case where a finger enters the server screen 7B when a horizontal gesture is made to the object, the gesture determination part 504 may determine that swipe-in to the server screen 7B has been performed.

In the present embodiment, the horizontal slide area 7E is an area where a command or the like can be input by a finger being horizontally slid. However, the horizontal slide area 7E may be an area where a command or the like can be input by a finger being slid not leftward but rightward, that is, in a direction of the server screen 7B.

In the present embodiment, dragging and flicking have been cited as examples of gestures made by a finger being slid in the horizontal slide area 7E. However, the present invention can also be applied to a case where pinch-out or the like is performed.

The gesture determination part 504 may disable an operation on the MFP screen 7A if a period of time for which the MFP screen 7A is touched exceeds a certain period of time. Subsequently, when a finger enters the server screen 7B, the gesture determination part 504 may determine that slide-in to the server screen 7B has been performed.

Alternatively, even in the case where a slide operation is performed by a user sliding a finger from the non-horizontal slide area 7F to the server screen 7B, the gesture determination part 504 may determine that the slide operation is a gesture made only to the non-horizontal slide area 7F if another operation is being performed on the MFP screen 7A.

In addition, it is possible to change, as appropriate, the entire configuration or the configuration of each part, details of processes, the sequence of processes, a screen configuration, and the like of the multifunction machine 1, the MFP unit 2, the server unit 3, and the panel controller 5 according to the gist of the present invention.

Although embodiments of the present invention have been described and illustrated in detail, the disclosed embodiments are made for purposes of illustration and example only and not limitation. The scope of the present invention should be interpreted by terms of the appended claims

What is claimed is:

1. An image processing apparatus comprising:
a display part that causes a touch panel display to display a first screen and a second screen adjacent to each other, the second screen being provided with a first area which is responsive to a slide operation performed by a pointer being slid in a direction of the first screen and a second area which is not responsive to the slide operation;
a determiner that determines that the slide operation has been performed not on the first screen but in the first area in a case where the slide operation has been performed from the first area to the first screen; and
a processor that performs a process based on a result of determination by the determiner.

2. The image processing apparatus according to claim 1, wherein
in a case where the slide operation has been performed from the second area to the first screen, the determiner determines that the slide operation has been performed in the second area and on the first screen.

3. The image processing apparatus according to claim 2, wherein
even in a case where the slide operation has been performed from the second area to the first screen, the determiner determines that the slide operation has been performed only in the second area when the slide operation has been performed while another operation is being performed on the second screen.

4. The image processing apparatus according to claim 1, wherein
in a case where a next slide operation has been performed from the first area to the first screen within a predetermined period of time after the slide operation having been performed from the first area to the first screen, the determiner determines that the next slide operation has been performed not in the first area but on the first screen.

5. The image processing apparatus according to claim 1, wherein
in a case where a next slide operation has been performed from the first area to the first screen within a predetermined period of time after the slide operation having been performed from the first area to the first screen, and where no other operation has been performed between the slide operation and the next slide operation, the determiner determines that the next slide operation has been performed not in the first area but on the first screen.

6. The image processing apparatus according to claim 1, wherein
in a case where a period of time for which the first screen is touched by the pointer exceeds a predetermined period of time, the determiner determines that the slide operation has been performed on the first screen.

7. The image processing apparatus according to claim 1, wherein
the display part causes the second screen to be displayed at lower brightness than normal for a predetermined period of time after the slide operation is performed.

8. The image processing apparatus according to claim 1, wherein
a scroll bar for scrolling is disposed in the first area, and
in a case where the slide operation has been performed from one of ends of the scroll bar, which is closer to the first screen, the display part performs output for notifying a user that the slide operation has been performed across a boundary between the first screen and the second screen.

9. The image processing apparatus according to claim 1, wherein
in a case where the slide operation has been performed from the second area to the first area, the determiner determines that the slide operation has been performed not in the second area but in the first area.

10. The image processing apparatus according to claim 1, wherein
in a case where the slide operation has been performed from the second area to the first screen via the first area, the determiner determines that the slide operation has been performed on the first screen, neither in the second area nor in the first area.

11. The image processing apparatus according to claim 1, wherein
even in a case where the slide operation has been performed from the first area to the first screen, the determiner determines that the slide operation has been performed not on the second screen but on the first screen when the slide operation has been started from a position within a predetermined distance from a boundary between the first screen and the second screen.

12. The image processing apparatus according to claim 1, wherein
in a case where the slide operation does not end even after a predetermined period of time or more, the determiner determines that the slide operation has been canceled.

13. The image processing apparatus according to claim 1, wherein
in a case where while the slide operation is being performed in the first area, another operation has been performed on the first screen, the determiner determines that the slide operation has been canceled.

14. The image processing apparatus according to claim 1, wherein
the first area is narrowed in a case where the slide operation has been consecutively performed at intervals which are equal to or less than a predetermined period of time.

15. An image processing apparatus comprising:
a display part that arranges a plurality of screens, and causes a touch panel display to display the plurality of screens;
a determiner that determines that a slide operation, which is performed by a pointer being slid, has been performed on any one of the plurality of screens in a case where the slide operation has been performed across the plurality of screens; and
a processor that performs a process based on a result of determination by the determiner.

16. The image processing apparatus according to claim 15, wherein
the determiner determines that the slide operation has been performed on a screen having been touched by the pointer last of the plurality of screens.

17. The image processing apparatus according to claim 15, wherein
the determiner determines that the slide operation has been performed on a screen on which the pointer has traveled a distance that is longest of distances traveled on the plurality of screens.

18. A screen handling method comprising:
causing a touch panel display to display a first screen and a second screen adjacent to each other, the second screen being provided with a first area which is responsive to a slide operation performed by a pointer being slid in a direction of the first screen and a second area which is not responsive to the slide operation;
determining that the slide operation has been performed not on the first screen but in the first area in a case where the slide operation has been performed from the first area to the first screen; and
performing a process based on a result of determination made in the determination process.

19. A non-transitory recording medium storing a computer readable program to be used in a computer for controlling a touch panel display, the computer program causing the computer to perform:
causing a touch panel display to display a first screen and a second screen adjacent to each other, the second screen being provided with a first area which is responsive to a slide operation performed by a pointer being slid in a direction of the first screen and a second area which is not responsive to the slide operation;
determining that the slide operation has been performed not on the first screen but in the first area in a case where the slide operation has been performed from the first area to the first screen; and
a process corresponding to a result of the determination process.
